(19) United States
(12) Patent Application Publication
(10) Pub. No.: US 2018/0330709 A1
(43) Pub. Date: Nov. 15, 2018

(54) Sound Attenuation Using Metal-Organic Framework Materials

(71) Applicants: Battelle Memorial Institute, Richland, WA (US); CertainTeed Gypsum, Inc., Malvern, PA (US)

(72) Inventors: B. Peter McGrail, Pasco, WA (US); Satish K. Nune, Richland, WA (US); Ki Won Jung, Richland, WA (US); Gaurav V. Pattarkine, Shrewsbury, MA (US); Michael S. Urso, Spokane, WA (US); Peter Mayer, Tampa, FL (US); Zhiqiang Shi, Shrewsbury, MA (US)

(21) Appl. No.: 15/591,152

(22) Filed: May 10, 2017

(51) Int. Cl. G10K 11/168; B32B 13/08; B32B 13/02; E04B 1/86; E04C 2/26; E04C 2/34

(52) U.S. Cl. CPC G10K 11/168; B32B 13/08; B32B 13/02; E04B 1/86; B32B 2607/00; E04C 2/3405; B32B 2264/0214; B32B 2307/102; E04C 2/26

(57) ABSTRACT

Metal-organic framework materials can be used as acoustic attenuation materials. A sound attenuation material includes a metal-organic framework material that attenuates audible frequency sound incident thereon. The sound attenuating material can be used in acoustic applications such as building construction materials.

### FIELD

This relates to the field of acoustics and, more particularly, to sound attenuating materials.

### BACKGROUND

Building board, a widely used building construction material, is commonly referred to as drywall, plasterboard, or wallboard. It is used to form the interior walls of buildings, exterior sheathing for weather protection, and interior facing for structures such as stairwells, elevator shafts, and ductwork.

Gypsum board is a popular form of building board. Gypsum building boards are typically made of a cementitious gypsum slurry sandwiched between a pair of fibrous or paper liners. Gypsum slurry is a semi-hydrous form of calcium sulfate. Types of gypsum boards include: (1) paper lined gypsum boards, (2) glass-reinforced gypsum (“GRG”) boards, and (3) embedded glass-reinforced gypsum (“EGRG”) boards.

Conventional building boards provide at least some degree of sound attenuation, but not enough in many circumstances. A wall made of wood studs with a single layer of ½ inch drywall on each side has a sound transmission class (“STC”) rating of 33. Adding fiberglass insulation only raises STC rating to 36. Within this range, loud speech is audible across the wall. Loud speech is not audible at STC=45. Very loud sounds, such as loud music, are inaudible at STC=50. Most sounds are inaudible when STC>60.

Specialized soundproofing wallboards have been developed that include soundproofing materials. One of them is called SILENTFX® (CertainTeed Gypsum, Inc., Malvern, Pa. USA). Walls including SILENTFX® wallboards are reported to have STC=57. Although this is effective, there is still a need for new sound attenuation materials that might attenuate even more sound, especially at frequencies below 125 Hz not normally covered by STC. This may allow soundproofing wallboards to be made of less material than conventional soundproofing wallboards. Such a material could also be used for other acoustic applications besides building boards.

### BRIEF SUMMARY

It has been discovered that metal-organic framework materials (MOFs) attenuate sound in the audible frequency range. MOFs are, therefore, useful to dampen sound and to make sound-proofing or other acoustical products.

In one aspect, a method of dampening sound includes positioning a sound attenuation material along a sound travel pathway for attenuating sound waves that travel along the sound travel pathway. The sound attenuation material includes a metal-organic framework material.

Some examples of the sound attenuation material include a wallboard, an acoustic tile, and/or a coating.

Some examples of the metal-organic framework material include aluminum terephthalate, iron-1,3,5-benzene tricarboxylate, copper-1,3,5-benzene tricarboxylate, nickel-2,5-dihydroxyterephthlate, aluminum glutarate, and/or aluminum adipate.

The method may further include a substrate with which the sound attenuation material is in contact and the substrate and sound attenuation material are arranged in adjacent substantially parallel layers. Gypsum is one example of such a substrate.

The metal-organic framework material may be distributed throughout a cementitious wallboard material. The cementitious wallboard material may include gypsum.

The sound attenuation material may be part of a building wallboard.

The sound attenuation material may be part of a building wallboard where the building wallboard includes gypsum and the metal-organic framework material has a density of 0.1 g/cm3 to 0.9 g/cm3.

A compressed pellet of the metal-organic framework material may have a transmission loss of at least 1 dB/mm.

In another aspect, a building construction product includes a building construction substrate having a sound attenuation material in contact therewith. The sound attenuation material includes metal-organic framework material effective for attenuating audible frequency sound.

Some examples of the building construction substrate include a wallboard, an acoustic tile, and/or a coating.

Some examples of the metal-organic framework material include aluminum terephthalate, iron-1,3,5-benzene tricarboxylate, copper-1,3,5-benzene tricarboxylate, nickel-2,5-dihydroxyterephthlate, aluminum glutarate, and/or aluminum adipate.

The substrate and sound attenuation material may be arranged in adjacent substantially parallel layers.

The substrate may include gypsum.

The substrate may be a cementitious wallboard material. The cementitious wallboard material may include gypsum.

The sound attenuation material may be part of a building wallboard.

The sound attenuation material may be part of a building wallboard where the building wallboard includes gypsum and the metal-organic framework material has a density of 0.1 g/cm3 to 0.9 g/cm3.

A compressed pellet of the metal-organic framework material may have a transmission loss of at least 1 dB/mm.

In yet another aspect, a building panel includes a pair of planar sheets of panel material defining a pair of substantially parallel planes, a cementitious material layer positioned between the planar sheets, and a sound attenuation material positioned between the planar sheets or over at least one of the planar sheets. The sound attenuation material includes a metal-organic framework material that attenuates audible frequency sound.

Some examples of the metal-organic framework material include aluminum terephthalate, iron-1,3,5-benzene tricarboxylate, copper-1,3,5-benzene tricarboxylate, nickel-2,5-dihydroxyterephthlate, aluminum glutarate, and/or aluminum adipate.

The cementitious material layer may include gypsum.

The sound attenuation material may form a layer between the planar sheets that is substantially parallel to the cementitious material layer.

The metal-organic framework material may be distributed throughout the cementitious material layer.

The pair of planar sheets of panel material may be attached to the cementitious material layer on opposed sides of the cementitious material layer and the cementitious material layer may include gypsum and the metal-organic framework material may have a density of 0.1 g/cm3 to 0.9 g/cm3.

A compressed pellet of the metal-organic framework material may have a transmission loss of at least 1 dB/mm.

### BRIEF DESCRIPTION OF THE DRAWINGS

FIG. 1 is an example set of flexible ligands that can be used as linkers in MOFs;

FIG. 2 is a reaction scheme illustrating the substitution of ligand FL1 for terephthalate in the MOF material MIL-53(Al);

FIG. 3 is block diagram illustrating a sound dampening method aspect;

FIG. 4 is a perspective view of an example of an acoustic attenuation product aspect;

FIG. 5 is a perspective view of another example of an acoustic attenuation product aspect;

FIG. 6 is a perspective view of a building panel aspect;

FIG. 7 is a perspective view of another example of a building panel aspect;

FIG. 8 is a room having walls made of the building panel of FIG. 6;

FIG. 9 is a graph of transmission loss vs. frequency for different MOF materials;

FIG. 10 is a graph of transmission loss vs. frequency for the MOF material NiDHTA with and without a binder;

FIG. 11 is a graph of transmission loss vs. frequency for various MOF materials including MOF materials with flexible linker ligands;

FIG. 12 is a graph of transmission loss vs. frequency for the MOF material MIL-53(Al)-AA combined with a commercial wallboard;

FIG. 13 is a graph of transmission loss vs. frequency for the MOF material MIL-53(Al)-GA combined with a commercial wallboard;

FIG. 14 is a graph of transmission loss vs. frequency for the MOF material BASOLITE F300 combined with a commercial wallboard; and

FIG. 15 is a graph of transmission loss vs. frequency for the MOF material BASOLITE C300 combined with a commercial wallboard.

### DETAILED DESCRIPTION OF EMBODIMENTS

This disclosure describes examples of aspects and embodiments, but not all possible aspects embodiments of the sound attenuation materials, acoustic attenuation products, building panels, or related methods. Where a particular feature is disclosed in the context of a particular aspect or embodiment, that feature can also be used, to the extent possible, in combination with and/or in the context of other aspects and embodiments. The sound attenuation materials, acoustic attenuation products, building panels, and related methods may take many different forms and should not be construed as limited to only the aspects and embodiments described here.

### Sound Attenuation Materials

A sound attenuation material aspect is first described. The sound attenuation material includes at least one MOF material, which is effective to attenuate sound waves. As discussed in the examples section, MOFs attenuate sound in the audible frequency range.

The acoustic attenuation properties of a material can be measured using conventional techniques. Acoustic attenuation may be expressed as the transmission loss of a sound passing through the material at a given frequency or absorption of sound by a material at a given frequency. Typical units for transmission loss are dB or dB/mm, where mm represents the thickness of the material in millimeters.

Audible frequencies are audible to the average human. They typically range from about 20 Hz to about 20 kHz. The sound attenuation material attenuates sound across at least a part of this frequency range. It is capable of attenuating sound incident on the material and/or passing through the material. Acoustic attenuation may occur by sound absorption, sound insulation, or another sound attenuation mechanism.

The sound attenuation properties of a MOF material may be evaluated by measuring the transmission loss through a compressed pellet of the MOF material. The compressed pellet of the MOF material may have a transmission loss of at least 1 dB/mm for sound having a frequency of 800 Hz, for example.

The sound attenuation material may be constructed in many different ways. It may, for example, be constructed in the form of a coating, a wallboard, or an acoustic tile. It may also be part of an audio speaker or an acoustic transmission line. There are many other possible applications for the sound attenuation material.

When the sound attenuation material is constructed as a liquid coating, the MOF material may be blended with conventional coating materials such as polymers used in building construction. The coating may be applied to a substrate by spraying, rolling, brushing, caulking, or any other conventional coating application technique. The coating may be, for example, a paint, adhesive, or acoustic caulk, or the like.

When the sound attenuation material is constructed as part of a wallboard, the MOF material may be blended with conventional wallboard materials that are then bound together with a binder. The binder is a substance that, when dried, causes the panel materials to stick together to form the rigid structure. Examples of binders that may be suitable include polyvinyl alcohol. The sound attenuation material may also be applied as a coating to the wallboard.

In another example, the sound attenuation material may be compressed together with sufficient force to form a rigid panel with or without a binder.

### MOF Materials

The MOF materials may be employed in crystalline, polycrystalline, powder, pellet, extrudate, bead and/or monolith form. There may also be other acoustic applications for MOF materials in other forms.

A MOF material is a coordination solid with organic ligands bonded to one or metal ions. They typically include metal ions or metal ion-containing clusters coordinated together with organic ligands or linkers to form one, two, or three-dimensional coordination structures with pores.

MOF materials that may be used as part of a sound attenuation material often have low-densities and high-surface areas. Some suitable MOFs have a density of 0.1 g/cm³ to 0.9 g/cm³. A typical surface area of a MOF is 1 m²/g to 10,000 m²/g.

The list of possible MOFs that may be used in the sound attenuation material is extensive because there are many thousands of different combinations of metal ions and organic linkers that researchers have used to make MOFs. Not all of the possible MOFs that may be used are described in this disclosure.

It is to be understood that, in general, a MOF effective for attenuating audible sound may be suitable for use in the sound attenuation material, regardless of whether the MOF is listed or discussed here.

As mentioned above, MOFs are made of metal ions and organic linkers. Some of the metal ions used to make MOFs include ions of the metals listed in Table 1. Some of the organic linkers that may be used are listed in Table 2.

Rather than referring to MOFs by their chemical names, MOFs are often recognized by shorthand names developed by MOF researchers or their institutions. The shorthand name is essentially a code that helps identify the metal ion(s) and linker(s). Table 3 lists the shorthand names for a few examples of MOFs, some of which are commercially available. Table 4 provides surface area and pore volume data for some MOF examples. Four MOFs are now described in more detail.

MIL-53 (Al) is aluminum terephthalate and is commercially available from Sigma Aldrich under the name BASOLITE A100. MIL-53 (Al) has a reported surface area of 1,100-1,500 m²/g and a density of 0.4 g/cm³.

Fe-BTC is iron-1,3,5-benzene tricarboxylate and is commercially available from Sigma Aldrich under the name BASOLITE F300. Fe-BTC has a reported surface area of 1,300-1,600 m²/g and a density of 0.16-0.35 g/cm³.

Cu-BTC is copper-1,3,5-benzene tricarboxylate and is commercially available from Sigma Aldrich under the name BASOLITE C300. Fe-BTC has a reported surface area of 1,500-2,100 m²/g and a density of 0.35 g/cm³.

Ni-DHTA, also called MOF-74-Ni, is formally nickel-2,5-dihydroxyterephthalate.

A procedure for making Ni-DHTA was reported by Dietzel et al., in Journal of Materials Chemistry, Vol. 19, pages 7362-7370 (2009). To a fresh teflon container was added 2,5-dihydroxyterephthalic acid (1.486 g, 7.5 mmol) followed by THF (25 mL) and a solution of nickel acetate tetrahydrate (3.733 g, 15 mmol) in water (25 mL). The reaction mixture was sonicated for 2 min and then was placed in an autoclave, heated at 100 C for 24 h. Once the reaction mixture was cooled after heating for 24 h, the yellowish-brown product was separated by high speed centrifugation and washed with water (3 times) and by methanol (3 times) to remove any unreacted starting materials. The product was soaked in methanol for 24 h before exchanging the used methanol with fresh methanol. Substantially pure NiDHTA was obtained after 3 solvent exchanges.

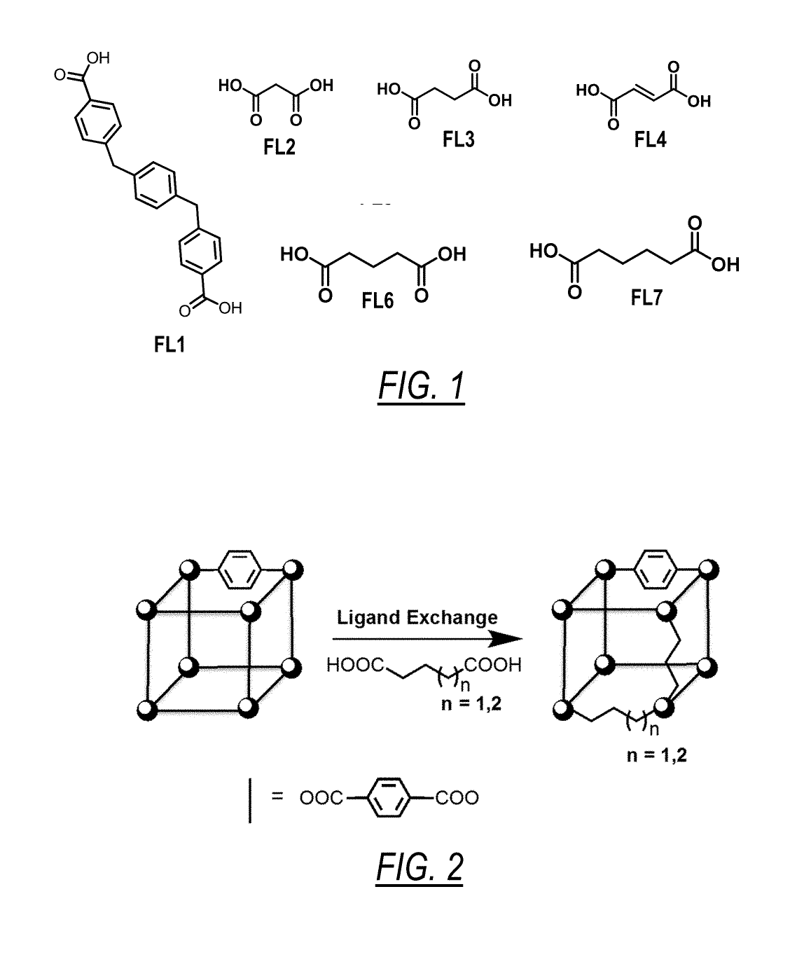

The linkers of many MOFs are short, relatively inflexible or rigid, organic ligands such as terephthalic acid, 1,3,5-benzene tricarboxylate, terephthalate, and 2,5 dihydroxyterephthalate. As shown in the Examples section, however, it was discovered that the flexibility of linker ligands affects the acoustic properties of the MOF. Consequently, linker ligands that are relatively flexible may be used to improve the acoustic attenuation properties of MOFs. Examples of some flexible ligands are shown in FIG. 1. FL6 is glutaric acid (“GA”). FL7 is adipic acid (“AA”). These are carboxylic acid compounds that are present in the MOF in their respective carboxylate forms.

Ligand exchange synthesis techniques may be used to exchange the original rigid ligand in a MOF with a more flexible ligand. A useful ligand exchange technique, called “post synthesis ligand exchange” is described in Chem. Eur. J, Vol. 20, pgs. 426-34 (2014), which is incorporated by reference in its entirety. This technique produces MOF sonocrystals.

The synthesis of a MOF with a flexible ligand is illustrated by the reaction scheme in FIG. 2 in which MIL-53(Al) is used as an example. MIL-53(Al) is a good starter material because it has two conformations with 40% unit cell volume difference between them. In FIG. 2, the terephthalate ligand is exchanged for FL1 to increase the MOF's flexibility.

Because of their different structures, MOF materials have different sound attenuation properties. The transmission loss of sound through a given MOF-containing sound attenuation material depends on the frequency of the sound. Some MOF materials exhibit greater sound attenuation at lower frequencies than at higher frequencies, whereas, the reverse is true for others. This means that sound attenuation properties of the sound attenuation material can be tuned by selecting MOF materials that attenuate sound to a desired degree within a given frequency range. If one desires to attenuate higher frequency sounds, it would be desirable to use a MOF material with favorable sound attenuation at higher frequencies. Mixtures of MOF materials with different sound attenuation properties can be used to obtain good sound attenuation across a desired part of the audible frequency spectrum.

Low frequency sounds such as bass notes and human voices typically have a frequency of about 2 kHz and below. Conventional sound attenuation materials are marginally effective at dampening these low frequency counds. MOFS, however, are particularly advantageous because they are effective for attenuating low frequency sounds.

### Sound Dampening Methods

A method of dampening sound using the sound attenuation material is illustrated in FIG. 3. The method involves positioning the sound attenuation material 20 along a sound travel pathway 22. The large arrow represents the sound travel pathway 22 and the thickness of the arrow represents the relatively high intensity of the sound originating from a sound source 24. The sound attenuation material attenuates the sound waves, making the intensity of the sound waves 26 on the other side of the sound attenuation material 20 smaller.

The sound attenuation material 20 may be positioned along the sound travel pathway by placing it so that the sound is incident on the sound attenuation material 20. The positioning mechanism will vary depending on the application for which the sound attenuation material 20 is used. Several different positioning mechanisms are described herein.

### Building Construction Products

The sound attenuation material is now described in connection with making building construction products, such as wallboards, acoustic tiles, and coatings.

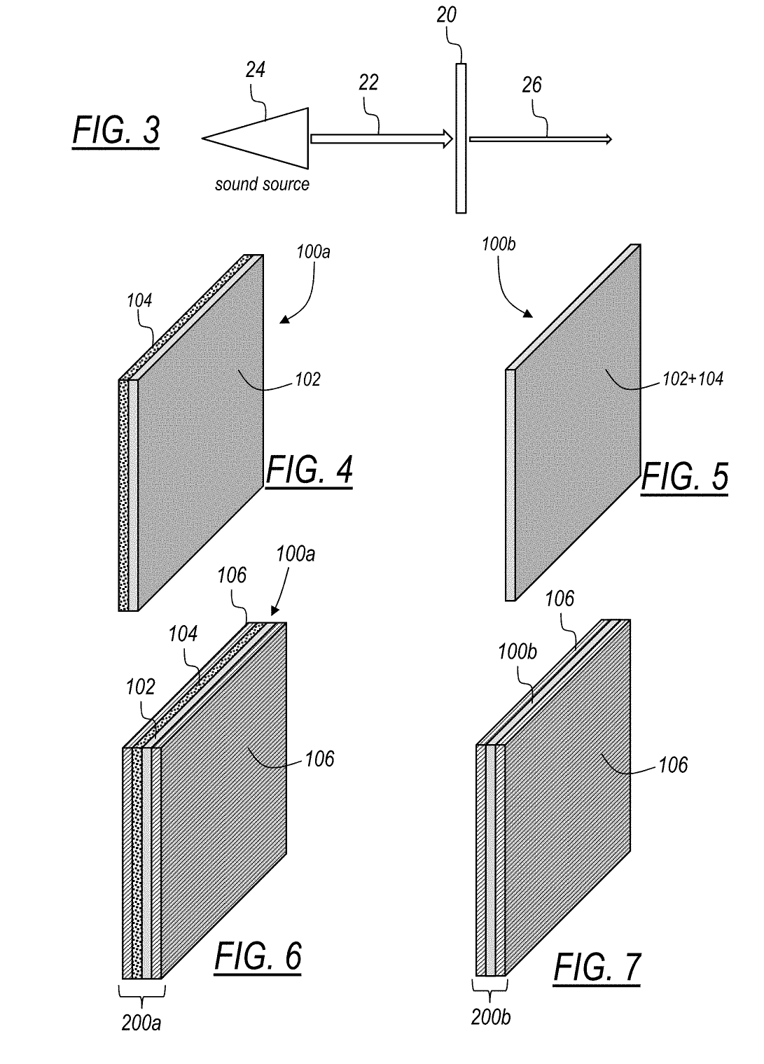

Referring to FIG. 4, an example of an acoustic attenuation product 100a useful for building construction includes an acoustic attenuation substrate 102 and a sound attenuation material 104.

The acoustic attenuation substrate 102 may be made, for example, of a substrate material used to make wallboards, such as cementitious materials, including but not limited to plaster, gypsum, or the like. A wallboard itself may serve as the substrate 102 in certain examples, such as when the sound attenuation material 104 is a wallboard coating.

In other examples, the substrate 102 may be an internal panel or layer of a wallboard. In yet other examples, the substrate 102 may be a fibrous mat or paper liner that supports an exterior of a wallboard.

In the example shown in FIG. 4, the substrate 102 and sound attenuation material 104 are arranged in adjacent substantially parallel layers. They may be affixed together to form a single composite structure or they may be treated as independent component parts, depending on the application. If affixed together, adhesive may be used to adhere the substrate 102 and sound attenuation material 104 together.

A different example of an acoustic attenuation product 100b, is shown in FIG. 5. The substrate material from the substrate 102 and sound attenuation material 104 are distributed throughout a mixture of the substrate material and sound attenuation material 104. In this case, the acoustic attenuation product 100b may form a monolithic structure. In a wallboard example, the sound attenuation material 104 may be distributed throughout the cementitious material, such as the gypsum, used to make the wallboard material.

These examples of the acoustic attenuation product, among other possible examples, may be used as a component of a building panel, such as a wallboard or the like. FIGS. 6 and 7 depict two of the many possible examples of a building panel 200a, 200b. The building panels 200a, 200b include a pair of planar sheets 106 of panel material defining a pair of substantially parallel planes with an acoustic attenuation product 100a, 100b arranged between the sheets 106. In the example of FIG. 6, the sound attenuation material 100a is arranged as a layer between the sheets 106 that is substantially parallel to the layer formed by the substrate 102. In the example of FIG. 7, the sound attenuation material 104 is distributed throughout the substrate material as in FIG. 4.

The building panels 200a, 200b may be adapted to form conventional gypsum-type wallboards. In that case, the substrate 102 may be a cementitious material such as gypsum and the panel material 106 is a thin, flexible sheet of paper, fabric, fibrous mat, or the like.

The conventional construction of different types of gypsum boards is known. A gypsum board typically includes a core of calcium sulfate dihydrate that is sandwiched between opposing paper sheets. This core is initially deposited in the form of a slurry of calcium sulfate hemihydrate (CaSO4.½H2O) and water. Once the slurry is deposited, it is rehydrated to form gypsum.

Materials may be combined with the gypsum core to modify its properties. One such material is starch. Starch can be added prior to rehydration. Starch functions as a binder within set gypsum and yields boards with higher compressive and flexural strength. It also strengthens the edges of the resulting board and improves the paper liner's bond to the core.

The gypsum core may include a plurality of internal voids to reduce the overall weight of the board. One example of a technique for achieving this is described in U.S. Pat. No. 6,706,128 to Sethuraman. Sethuraman discloses a method for adding air bubbles of different relative stabilities, whereby the air bubbles do not rupture before the slurry sets sufficiently to prevent the slurry from filing the void spaces left behind by ruptured bubbles. The result is a gypsum board with internal voids and with reduced weight.

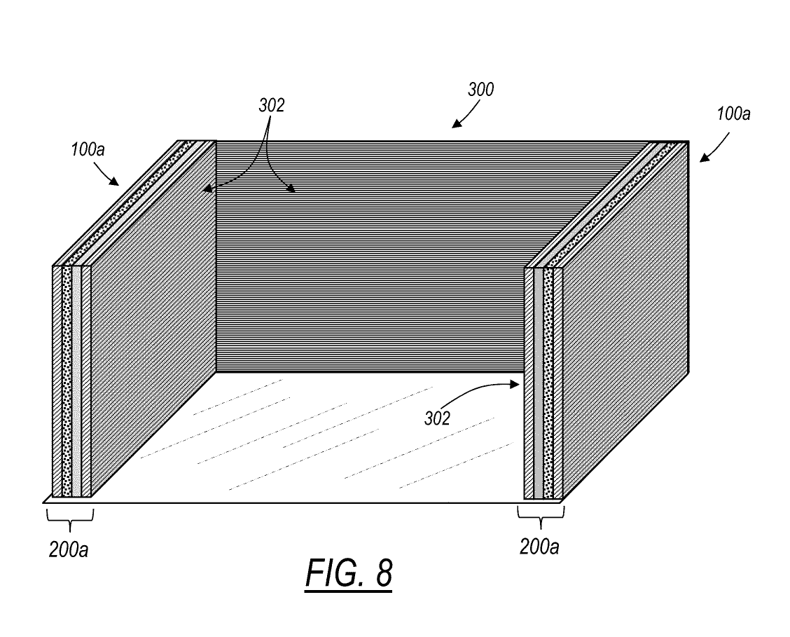

The acoustic attenuation products may be used to at least partially soundproof a room. Referring to FIG. 8, a room 300 of a building includes walls 302 made from the building panel 200a of FIG. 6. The walls 302 define a boundary of the room.

A corresponding method aspect includes forming a wall of a room of a building by positioning a building panel at a boundary of the room. The building panel includes the sound attenuation material. The sound attenuation material includes at least one metal-organic framework material.

The sound attenuation material 104 may be incorporated into an acoustic panel. An acoustic panel is a sound dampening wall, ceiling, or floor panel that is used to dampen sound. Acoustic panels include items such as ceiling tiles, floor tiles, and wall tiles. They may be mounted onto a wall, floor, or ceiling. In this context the substrate 102 of FIGS. 4 and 5 is the material used to make the acoustic panel.

The sound attenuation material 104 may be incorporated into a coating. Coatings include materials such as paints, adhesives, caulks, or the like. In this context, the coating is illustrated by FIG. 5 where the substrate includes the non-MOF materials used to make the coating. These non-MOF materials may include conventional polymers used in building construction materials, for example.

### EXAMPLES

These examples show that MOFs attenuate sound in the audible frequency range. The scope of the possible embodiments is not limited to what these examples teach.

### Example 1

### Sound Attenuation Measurements on MOFs

Preparation of MOF Sound Attenuation Material.

MOF-containing sound attenuation materials were prepared by making compressed disc-shaped pellets of MOF samples. MOF crystals were pulverized to a fine powder with a mortar and pestle. The powder was loaded into a die and pressure of 6-7 tons was applied to the powder for about 1 minute to compress the powder particles together. The diameter of each pellet was about 100 mm and the thickness was about 2 to 3 mm.

The mechanical integrity of the pellets was enhanced in some samples by mixing several drops of 5% polyvinyl alcohol (PVA) with the powder prior to compression. In these cases 35-40 tons of pressure was applied without imparting substantial defects to the pellets.

Sound Attenuation Measurements.

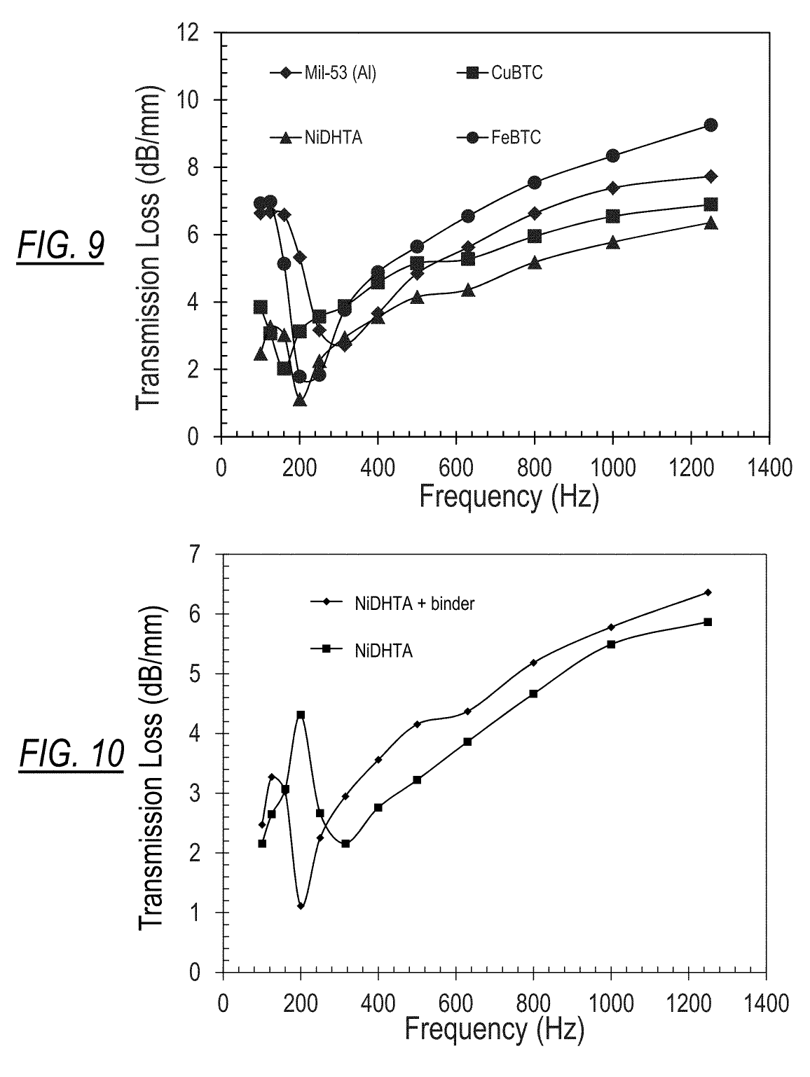

The sound attenuation properties of different MOFs were measured in an acoustic impedance tube. FIG. 9 shows the sound attenuation results from four different MOF pellets from about 100 Hz to about 1.2 kHz. The transmission loss in dB/mm is plotted vs. frequency. Each of the MOFs exhibited a non-linear frequency dependent spectrum with a local maximum at low frequencies eventually followed by a gradual rise in transmission loss as the frequency increased. The data show that MOFs are effective sound attenuation materials.

Effect of the Binder.

FIG. 10 is a plot comparing the sound attenuation properties of a Ni-DHTA pellet vs. a Ni-DHTA pellet with 5% PVA binder. Both samples imparted transmission losses across the frequency spectrum. Above about 300 Hz, the transmission loss-behavior was very similar.

### Example 2

### Sound Attenuation Measurements on MOFs with Flexible Ligands

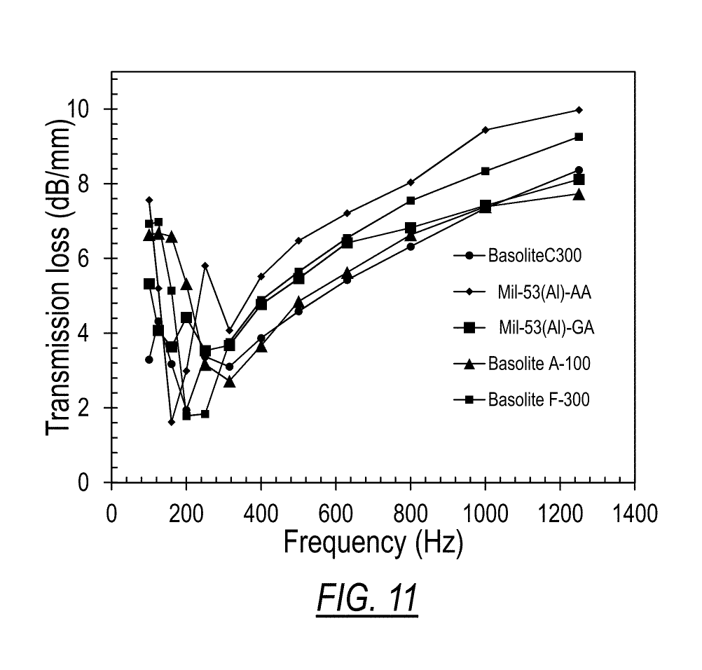

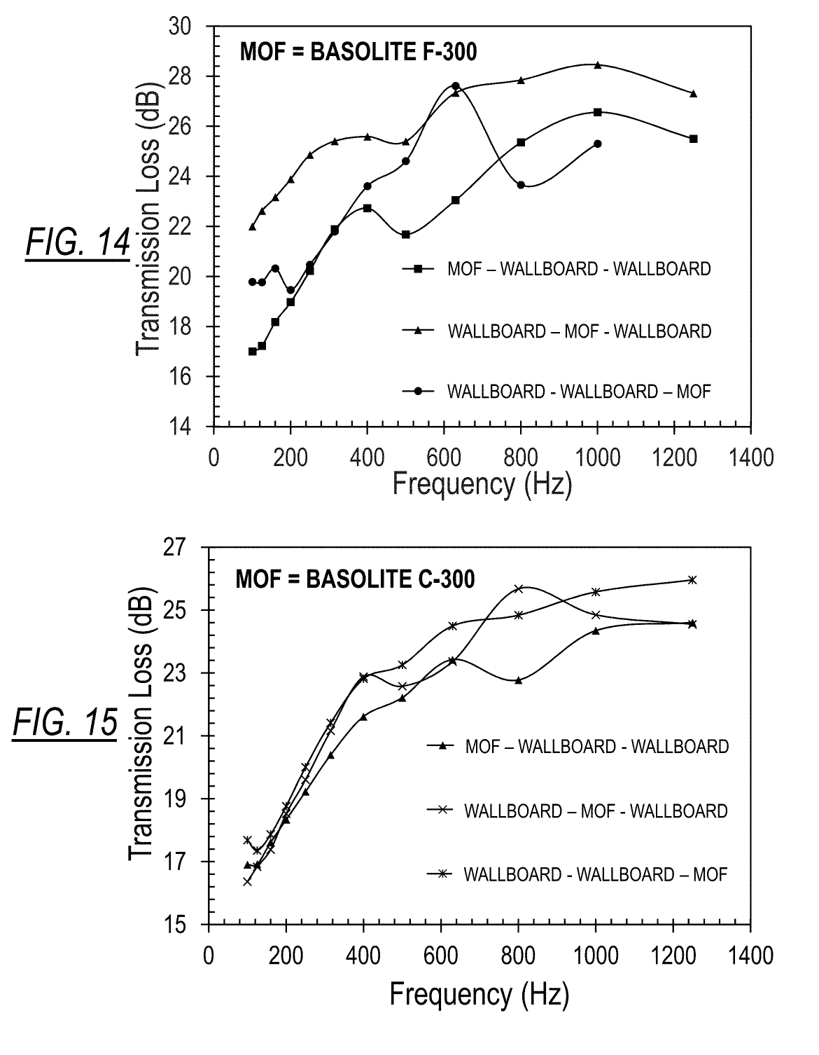

The terephthalate ligand of MIL-53(Al) was substituted with the two flexible ligands glutarate and ad-pate. In FIGS. 11-15, MIL-53(Al)-AA refers to MIL53(Al) with an adiepate linker and MIL-53(Al)-GA refers to MIL53(Al) with a glutarate linker.

MIL53(Al)-AA and MIL53(Al)-GA were prepared by the following procedure. 500 mg of MIL-53 was mixed with 100-375 mg of the flexible ligands and of 25 ml THF was added to the mixture. The mixture was sonicated for one minute. The mixture was then transferred to a Teflon autoclave, which was tightly sealed and heated to 120° C. for 24 h. After cooling, the resulting solids were separated by centrifugation. The suspension was centrifuged and the solid obtained was thoroughly washed with dimethyl formamide (DMF, 10 mL) two times and with THF (10 mL, 2 times) to remove unreacted flexible ligand from the reaction mixture. The solid obtained was dried and its identity was confirmed with powder X-ray diffraction, water sorption, and BET surface area measurements.

FIG. 11 is a graph showing the transmission loss vs. frequency for pellets of MIL-53(Al)-AA and MIL-53(Al)-GA in comparison to pellets of BASOLITE C300, BASOLITE A-100, and BASOLITE F-300. MIL-53(Al)-AA and MIL-53(Al)-GA exhibited larger transmission losses above about 400 Hz than the other MOFs tested.

### Example 3

### Sound Attenuation Measurements on Wallboards Including MOFs

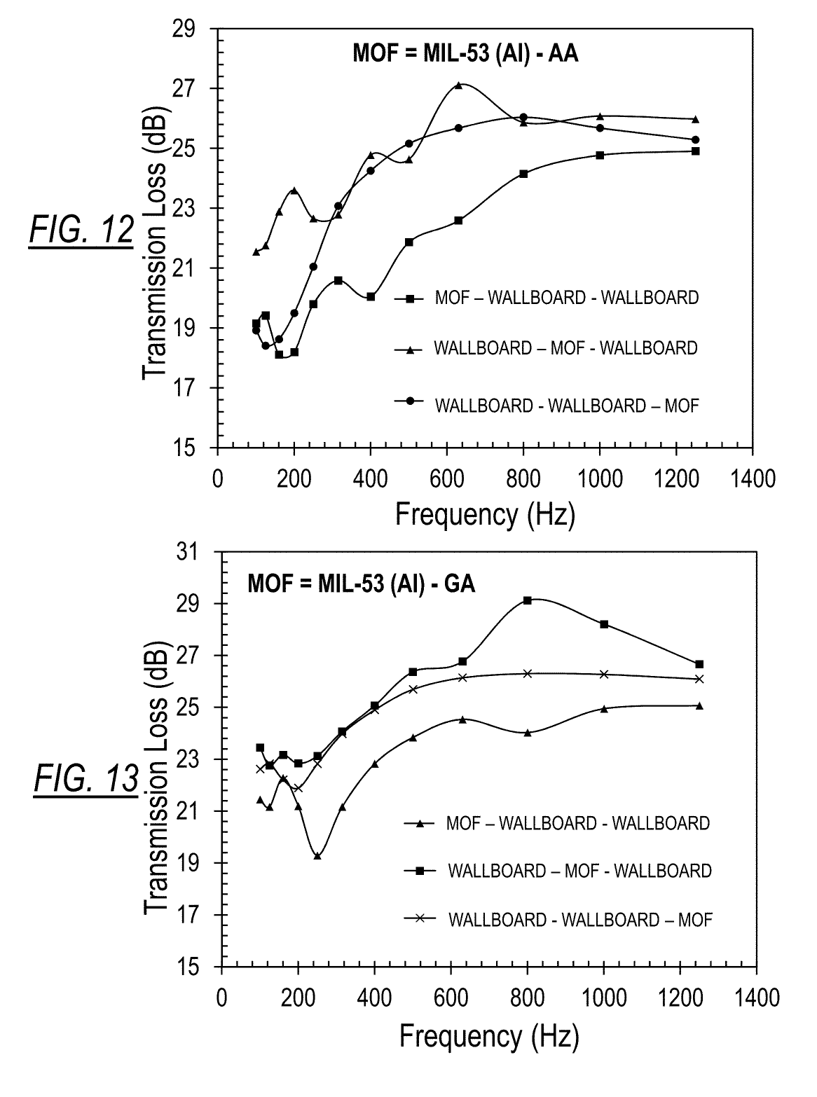

Wallboard samples and MOF pellets were evaluated for sound attenuation properties. EASILITE® wallboard samples were combined with MOF pellets. The composite was held together by compression and without an adhesive. The transmission loss measurement results for different configurations of the MOF pellet relative to the incident acoustic wave are shown in FIGS. 12-15.

The legend in each of the graphs indicates how the pellets were configured. MOF-WALLBOARD-WALLBOARD means that the MOF pellet was positioned closer to the sound source. WALLBOARD-MOF-WALLBOARD means that the MOF pellet was positioned between two EASILITE® pellets. This example can be illustrated by FIG. 7 where the MOF pellet is the sound attenuation material 100b and the EASILITE® pellets are the planar sheets 106. WALLBOARD-WALLBOARD-MOF means that the MOF pellet was furthest from the sound source. These data show that MOFs can be used to improve the sound attenuating properties of building boards across a broad range of audible frequencies.

TABLE 1
Examples of Metal Ions in MOFs

Ag, Al, Be, Ca, Cd, Ce, Co, Cr, Cu, Dy, Er, Eu, Fe, Ga, Gd, Ho,
In, Li, Mg, Mn, Mo, Nd, Ni, Sc, Sm, Sr, Tb, Ti, Tm, V, W, Y, Yb,
Zn, and Zr, among others.

TABLE 2
Examples of Linkers in MOFs

1,2,4,5-tetrakis(4-carboxyphenyl)benzene
1,3,5-tris(4′-carboxy[1,1′-biphenyl]-4-yl)benzene
1,3,5-tris(4-carboxyphenyl)benzene
2,5-dihydroxyterephthalic acid
2,6-naphthalenedicarboxylic acid
2-hydroxyterephthalic acid
2-methylimidazole
3,3′,5,5′-tetracarboxydiphenylmethane
4,4′,4″-s-triazine-2,4,6-triyl-tribenzoic acid
9,10-anthracenedicarboxylic acid
biphenyl-3,3′,5,5′-tetracarboxylic acid
biphenyl-3,4′,5-tricarboxylic acid
imidazole
terephthalic acid
2-amino terephthalic acid
trimesic acid
[1,1′:4′,1″]terphenyl-3,3′,5,5′-tetracarboxylic acid
Adipic acid or adipate
Glutaric acid or glutarate

TABLE 3
Examples of MOFs

Al(OH)(BDC)
Al-MIL-53-X
BCF-1
BCF-2
BIF-10
BIF-11
BIF-12
BZ1
CAU-5
CAUMOF-8
CPF-1
CPM-18-Nd
CPM-18-Sm
CPM-20
CPM-24
CPO-20
CPO-21
CPO-22
CPO-26-Mg
CPO-26-Mn
CPO-27-Co
CPO-27-Mg
CPO-27-Ni
CPO-27-Zn
CdIF-1
Ce-BTC
Ce-MDIP1
Ce-MDIP2
Co(Im)₄
Co/DOBDC
Co₃(BHTC)₂
Co₃(BTC)₂•12H₂O
Cr₃(BTC)₂
Cu(BDC-OH)
Cu-BTC
Cu-TPTC
Cu₂(bptc)(H₂O)₂
CuTATB-30
CuTATB-60
DO-MOF
DTO-MOF
DUT-8(Ni)
Dy(BTC)(DMF)₂•H₂O
Dy(TATB)(H₂O)
Er(BTC)(DMF)₂•H₂O
Er(BTC)(H₂O)
Er(TATB)(H₂O)
Eu(1,3,5-BTC)
Eu(BTC)(H₂O)
Eu(TATB)(H₂O)
Eu(TPA)(FA)
Eu₁₋ₓTbₓ-MOFs
Fe-BTC
Ga-Im
Gd(BTC)(H₂O)
Gd(TATB)(H₂O)
Gd(TPA)(FA)
HKUST-1
HZIF-1Mo
HZIF-1W
Ho(BTC)(DMF)₂•H₂O
Ho(BTC)(H₂O)
Ho(TATB)(H₂O)
IM-22
IRMOF-1
IRMOF-8
In-BTC
In-NDC
MAF-4
MCF-27
MIL-100 (Al)
MIL-100 (Cr)
MIL-100 (Sc)
MIL-101
MIL-101_NDC
MIL-103
MIL-110
MIL-45 (Co)
MIL-45 (Fe)
MIL-47
MIL-53 (Cr)
MIL-53(Al)
MIL-53(Fe)
MIL-53(Sc)
MIL-69
MIL-78
MIL-78 (Y, Eu)
MIL-88(Sc)
MIL-88B
MIL-88B(2OH)
MIL-88C-Cr
MIL-88C-Fe
MIL-88D
MIL-96
MOF-1 (Yb-MOF)
MOF-14
MOF-143
MOF-177
MOF-2
MOF-200
MOF-205 (DUT-6)
MOF-235
MOF-38
MOF-39
MOF-399
MOF-5
MOF-501
MOF-502
MOF-505
MOF-69B
MOF-74-Co
MOF-74-Fe
MOF-74-Mg
MOF-74-Ni
MOF-74-Zn
Mg/DOBDC
Mg₃(BHTC)₂
Mg₃(BPT)₂(H2O)₄
Mg₃(NDC)₃
MgDOBDC
Mn(BDC)(H₂O)₂
Mn₃(BHTC)₂
MnSO-MOF
NENU-11
NOTT-100
NOTT-101
NOTT-400
NOTT-401
Nd(BTC)(H₂O)
Ni-BDC
Ni/DOBDC
Ni₃(BTC)₂•12H₂O
NiDOBDC
PCN-12
PCN-12′
PCN-13
PCN-131
PCN-131′
PCN-132
PCN-132′
PCN-17 (Dy)
PCN-17 (Er)
PCN-17 (Y)
PCN-17 (Yb)
PCN-19
PCN-5
PCN-6
PCN-6′
PCN-9 (Co)
PCN-9 (Fe)
PCN-9 (Mn)
SCIF-1
SCIF-2
SNU-M10
SNU-M11
Sm(BTC)(H₂O)
Sr,Eu-Im
TIF-2
TIF-A1
TIF-A2
TO-MOF
TUDMOF-1
TUDMOF-3
Tb(BTC)(DMF)₂•H₂O
Tb(BTC)(H₂O)
Tb(TATB)(H₂O)
Tb(TPA)(FA)
Tb-BTC
Tm(BTC)(DMF)₂•H₂O
UL-MOF-1
UMCM-1
UMCM-150
UMCM-2
UTSA-25a
UTSA-36
UTSA-38
UiO-66(Zr)
UiO-66-X
Y(TATB)(H₂O)
Y-BTC
YO-MOF
Yb(BTC)(DMF)₂•H₂O
Yb(BTC)(H₂O)
ZBIF-1
ZIF-1
ZIF-10
ZIF-2
ZIF-3
ZIF-4
ZIF-60
ZIF-61
ZIF-62
ZIF-64
ZIF-65
ZIF-67
ZIF-70
ZIF-76
ZIF-8
Zn(Im)(aIm)
Zn-IM
Zn/DOBDC
Zn₂(BTC)
Zn₃(BTC)₂•12H₂O
Zn₃(NDC)₃
ZnPO-MOF
[Ag₄(HBTC)₂]
[Cd₃(TATB)₂]
[Mn₃(TATB)₂]
nZIF-8
p-BDC-Co
porph@MOM-10
rho-ZMOF
sod-ZMOF

TABLE 4
Surface Area and Pore Volume of MOF Examples

| MOF | BET Surface area (m²/g) | Pore volume (cm³g⁻¹) |
|---|---|---|
| MOF-5 | 3800 | 1.55 |
| UMCM-1-NH2 | 3920 | |
| PCN-66 | 4000 | 1.36 |
| Be₁₂(OH)₁₂(BTB)₂₄ | 4030 | |
| UMCM-1 | 4160 | |
| MIL-101 | 4230 | 2.15 |
| Bio-MOF-100 | 4300 | 4.30 |
| MOF-205 | 4460 | 2.16 |
| MOF-177 | 4750 | 1.59 |
| DUT-23-Co | 4850 | 2.03 |
| NOTT-116/PCN-68 | 4660/5110 | 2.17 |
| UMCM-2 | 5200 | 2.32 |
| NU-100 | 6140 | 2.82 |
| MOF-210 | 6240 | 3.6 |
| UN-109 | 7010 | 3.75 |
| NU110 | 7140 | 4.4 |

That which is claimed is:

1. A method of dampening sound, the method comprising positioning a sound attenuation material along a sound travel pathway for attenuating sound waves that travel along the sound travel pathway, the sound attenuation material including a metal-organic framework material.

2. The method of claim 1, wherein the sound attenuation material includes at least one member selected from the group: a wallboard, an acoustic tile, and a coating.

3. The method of claim 1, wherein the metal-organic framework material includes at least one member selected from the group: aluminum terephthalate, iron-1,3,5-benzene tricarboxylate, copper-1,3,5-benzene tricarboxylate, nickel-2,5-dihydroxyterephthlate, aluminum glutarate, and aluminum adiepate.

4. The method of claim 1, further comprising a substrate with which the sound attenuation material is in contact and the substrate and sound attenuation material are arranged in adjacent substantially parallel layers.

5. The method of claim 4, wherein the substrate includes gypsum.

6. The method of claim 1, wherein metal-organic framework material is distributed throughout a cementitious wallboard material.

7. The method of claim 6, wherein the cementitious wallboard material includes gypsum.

8. The method of claim 1, wherein the sound attenuation material is part of a building wallboard.

9. The method of claim 1, wherein:
the sound attenuation material is part of a building wallboard;
the building wallboard includes gypsum; and
the metal-organic framework material has a density of 0.1 g/cm³ to 0.9 g/cm³.

10. The method of claim 1, wherein a compressed pellet of the metal-organic framework material has a transmission loss of at least 1 dB/mm.

11. A building construction product comprising a building construction substrate having a sound attenuation material in contact therewith, the sound attenuation material including metal-organic framework material effective for attenuating audible frequency sound.

12. The building construction product of claim 11, wherein the building construction substrate is at least one member selected from the group: a wallboard, an acoustic tile, and a coating.

13. The building construction product of claim 11, wherein the metal-organic framework material includes at least one member selected from the group: aluminum terephthalate, iron-1,3,5-benzene tricarboxylate, copper-1,3,5-benzene tricarboxylate, nickel-2,5-dihydroxyterephthlate, aluminum glutarate, and aluminum adipate.

14. The building construction product of claim 11, the substrate and sound attenuation material are arranged in adjacent substantially parallel layers.

15. The building construction product of claim 14, wherein the substrate includes gypsum.

16. The building construction product of claim 11, wherein the substrate is a cementitious wallboard material.

17. The building construction product of claim 16, wherein the cementitious wallboard material includes gypsum.

18. The building construction product of claim 11, wherein the sound attenuation material is part of a building wallboard.

19. The building construction product of claim 11, wherein:
the sound attenuation material is part of a building wallboard;
the building wallboard includes gypsum; and
the metal-organic framework material has a density of 0.1 g/cm³ to 0.9 g/cm³.

20. The building construction product of claim 11, wherein a compressed pellet of the metal-organic framework material has a transmission loss of at least 1 dB/mm.

21. A building panel comprising:
a pair of planar sheets of panel material defining a pair of substantially parallel planes;
a cementitious material layer positioned between the planar sheets; and
a sound attenuation material positioned between the planar sheets or over at least one of the planar sheets, the sound attenuation material including a metal-organic framework material that attenuates audible frequency sound.

22. The building panel of claim 21, wherein the metal-organic framework material includes at least one member selected from the group: aluminum terephthalate, iron-1,3,5-benzene tricarboxylate, copper-1,3,5-benzene tricarboxylate, and nickel-2,5-dihydroxyterephthlate, glutarate, and adipate.

23. The building panel of claim 21, wherein the cementitious material layer includes gypsum.

24. The building panel of claim 21, wherein the sound attenuation material forms a layer between the planar sheets that is substantially parallel to the cementitious material layer.

25. The building panel of claim 21, wherein the metal-organic framework material is distributed throughout the cementitious material layer.

26. The building panel of claim 21, wherein:
the pair of planar sheets of panel material is attached to the cementitious material layer on opposed sides of the cementitious material layer;
the cementitious material layer includes gypsum; and
the metal-organic framework material has a density of 0.1 g/cm³ to 0.9 g/cm³.

27. The building panel of claim 21, wherein a compressed pellet of the metal-organic framework material has a transmission loss of at least 1 dB/mm.
